(19) United States
(12) Patent Application Publication
(10) Pub. No.: US 2009/0254553 A1
(43) Pub. Date: Oct. 8, 2009

(54) MATCHING MEDIA FOR MANAGING LICENSES TO CONTENT

(75) Inventors: David N. Weiskopf, Seattle, WA (US); Glen Rolfe, Sammamish, WA (US)

Correspondence Address: Corbis Corporation;c/o DARBY & DARBY P.C., P.O. BOX 770, Church Street Station, NEW YORK, NY, 10008-0770, US

(73) Assignee: Corbis Corporation, Seattle, WA (US)

(21) Appl. No.: 12/364,449

(22) Filed: Feb. 2, 2009

Related U.S. Application Data
(60) Provisional application No. 61/027,332, filed on Feb. 8, 2008.

(51) Int. Cl. G06F 17/30

(52) U.S. Cl. 707/6; 707/104.1; 707/E17.009; 707/E17.039

(57) ABSTRACT

Matching digital media available in a multi-node system. An example embodiment receives media from media providers. Metadata may also be included with digital media files or stored separately in a database. An example matching system generates, or receives a list of candidate nodes, such as network domains, to search for potential copies of digital media. The list may be defined and/or prioritized based on countries of interest, business sectors of interest, or other business rules. An example system crawls the domains to identify media files that appear on websites that are potential matches of the media files provided by the media providers. The system may download the media files, and evaluate them relative to the provided media files. The system identifies matches and identifies owners or operators of domains that had matching media files. The system generates case records for subsequent licensing or other action regarding the matched media files.

### CROSS REFERENCE TO RELATED APPLICATIONS

This application claims priority to U.S. Provisional Patent Application No. 61/027,332, filed Feb. 8, 2008, entitled “Matching Media For Managing Licenses To Content”, the entire contents of which are hereby incorporated by reference. This application is related to U.S. patent application Ser. No. 11/425,335, filed Jun. 20, 2006, entitled “Method And System For Managing Licenses To Content,” which claims priority to U.S. Provisional Patent Application No. 60/760,182, filed Jan. 18, 2006, also entitled “Method And System For Managing Licenses To Content,” the entire contents of both of which are hereby incorporated by reference.

### FIELD OF ART

The present invention generally pertains to managing one or more licenses to use content, and more particularly, to the identification of domains, filtering of domains and matching of digital content for managing licenses to matched content.

### BACKGROUND

The World Wide Web (“Web”) and other networks make it possible to publish digital media content including inter alia images, graphics, video clips, music, and the like. However, the ease with which digital media files can be copied makes it difficult for owners of digital media, sometimes referred to as “media providers” or “content owners”, to monitor, manage and control use of their digital media files. Another challenge that media providers face is the large number of websites and the fact that the digital media published on these websites rapidly changes. Thus, there is a need for new technologies that enable content owners to identify their digital media when it is used on the Web. There is further a need for technologies that enable content owners to enforce their rights over their digital media.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Preferred Embodiment, which is to be read in association with the accompanying drawings, wherein:

FIG. 1 illustrates a system diagram of one embodiment of an environment in which the invention may be practiced;

FIG. 2 shows one embodiment of a mobile device that may be included in a system implementing the invention;

FIG. 3 illustrates one embodiment of a network device that may be included in a system implementing the invention;

FIG. 4 is a simplified diagram of a media matching system for the Web, in accordance with an embodiment of the subject invention;

FIG. 5 is a logical flow diagram generally showing a process for matching media on the Web, in accordance with an embodiment of the subject invention;

FIG. 6 depicts the processing performed by a domain list generator, in accordance with an embodiment of the subject invention;

FIG. 7 depicts the processing performed by a commercial ranker that ranks the commercial potential of Web domains, in accordance with an embodiment of the subject invention;

FIG. 8 is a flowchart describing the processing steps performed by a media crawler, in accordance with an embodiment of the subject invention;

FIG. 9 is an example user interface for specifying high priority URL's for a media crawler, in accordance with an embodiment of the subject invention;

FIG. 10 is a flowchart describing the filtering and classification of images downloaded by a media crawler, in accordance with an embodiment of the subject invention;

FIG. 11 is a flowchart describing the processing of a media matcher that matches Web images that have been downloaded by a media crawler with images provided by a content provider, in accordance with an embodiment of the subject invention;

FIG. 12 depicts the processing performed by a case generator that creates and obtains information for case records, in accordance with an embodiment of the subject invention;

### DETAILED DESCRIPTION

The invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the invention may be embodied as methods, processes, systems, business methods, or devices. Accordingly, the present invention may take the form of an entirely hardware embodiment, an entirely software embodiment or an embodiment combining software and hardware aspects. The following detailed description is, therefore, not to be taken in a limiting sense.

Embodiments of the present invention enable content owners, also referred to as media providers, to identify instances on distributed nodes, such as the Web, where their digital media are published. Embodiments further enable content owners to obtain information about the owners of websites that publish content owners' digital media. For instance, the present invention is useful in products and systems that enable content owners to identify, track, and manage authorized use, actual unauthorized use, inadvertent unauthorized use, potential unauthorized use, or other use of digital media.

Embodiments of the present invention concern a system for matching of digital media on the Web or other network. An example embodiment is sometimes referred to as the “media matching system” or simply “the system”. The system receives media files from individuals or organizations, sometimes referred to as “media providers.” The system generates a list of candidate Web domains or other network sources to search for potential copies of digital media. In addition, or alternatively, an individual or organization (sometimes referred to as the “target generator”) provides the system with a specific candidate domain or specific media file. In the cases of domains, the system crawls the domains to identify media files that appear on websites that are potential matches of the media files provided by the media providers. The system may download said media files, attempts to match said media files with the provider-supplied and/or target generator-supplied media files. The system identifies matches and generates case records, or simply “cases”, for successfully matched media files. Records may also be generated where no match is made. For purposes of discussion, the term “digital media” or “media” generally refers to digital media files such as digital photographs (commonly referred to as “digital images” or simply “images”), videos, vector art, Flash animations, sound files, and the like. For embodiments discussed herein, digital media may comprise content that was originally created digitally, or content that was converted from analog to digital format. Digital media also includes descriptive information or “metadata” that provide information supplemental to the digital media. Metadata may be included within the digital media files or stored separately in a database. Note that metadata generally refers to information that is intrinsic to the media asset such as its known subject, keywords that describe the media content, media owner, media copyright holder, file format, and other information provided by a content provider or readily determined from the digital media content. Metadata enables or improves searching, browsing, filtering, matching and selection of media to purchase or license.

Embodiments of the subject invention describe a model in which a media provider, target-generator, or other information provider supplies digital media to a media matching server in order to determine if their digital media matches digital media on websites or elsewhere. In one embodiment, the media matching server is part of a media matching service that enables the media provider to define certain business rules, e.g. countries of interest, or business sectors of interest. Such media matching service provides a set of application features, provided through a web-based application or a non-web-based (e.g. desktop, server) application (“application”) that is operated by a “user”. Examples of the user may be media provider personnel or may be employees or staff from the media matching service who are working on behalf of the media provider or some third party. The user application provides application features that meet the requirements of the media provider, media matching service, party intending to use the media (“media user”), and/or party distributing or otherwise providing access to the media (“third party media distributor”). For example, the application may provide custom reports and/or the ability to determine if the matched media were licensed and if the license is in force.

### Illustrative Operating Environments

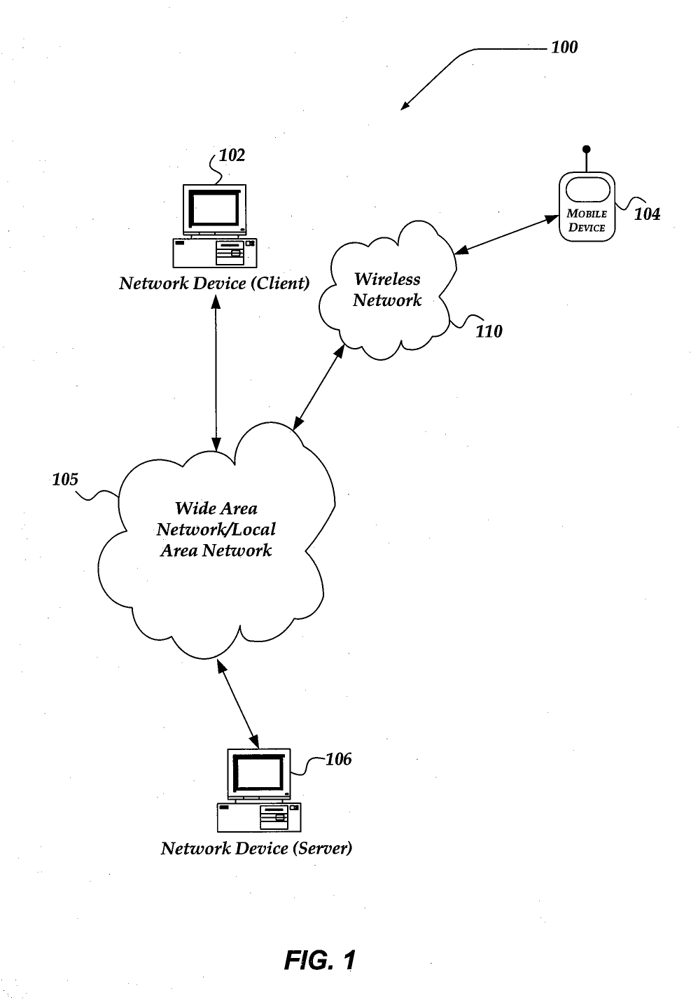

FIG. 1 shows components of an exemplary environment in which the invention may be practiced. Not all the components may be required to practice the invention, and variations in the arrangement and type of the components may be made without departing from the spirit or scope of the invention. As shown, system 100 of FIG. 1 includes local area networks (“LANs”)/wide area networks (“WANs”) 105, wireless network 110, server network device 106, client network device 102, and mobile device 104.

Generally, client network device 102 may include virtually any computing device capable of receiving and sending a message over a network, such as network 105, wireless network 110, and the like, to and from another computing device, such as server network device 106, mobile device 104, and the like. The set of such devices may include devices that typically connect using a wired communications medium such as personal computers, multiprocessor systems, microprocessor-based or programmable consumer electronics, network PCs, and the like. The set of such devices may also include devices that typically connect using a wireless communications medium such as cell phones, smart phones, pagers, walkie talkies, radio frequency (RF) devices, infrared (IR) devices, CBs, integrated devices combining one or more of the preceding devices, or virtually any mobile device, and the like. Similarly, client device 102 also may be any computing device that is capable of connecting using a wired or wireless communication medium such as a PDA, POCKET PC, laptop computer, wearable computer, and any other device that is equipped to communicate over a wired and/or wireless communication medium.

Client network device 102 may include a browser application that is configured to receive and to send web pages, web-based messages, and the like. The browser application may be configured to receive and display graphics, text, multimedia, and the like, employing virtually any web based language, including Standard Generalized Markup Language (SMGL), such as HyperText Markup Language (HTML), and so forth.

Client network device 102 may further include a client application that enables it to perform a variety of other actions, including, communicating a message, such as through a Short Message Service (SMS), Multimedia Message Service (MMS), instant messaging (IM), internet relay chat (IRC), mIRC, Jabber, and the like, between itself and another computing device. The browser application, and/or another application, such as the client application, a plug-in application, and the like, may enable client device 102 to communicate content to another computing device.

Mobile device 104 represents one embodiment of a client device that is configured to be portable. Thus, mobile device 104 may include virtually any portable computing device capable of connecting to another computing device and receiving information. Such devices include portable devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, and the like. As such, mobile device 104 typically ranges widely in terms of capabilities and features. For example, a cell phone may have a numeric keypad and a few lines of monochrome LCD display on which only text may be displayed. In another example, a web-enabled remote device may have a touch sensitive screen, a stylus, and several lines of color LCD display in which both text and graphics may be displayed. Moreover, the web-enabled remote device may include a browser application enabled to receive and to send wireless application protocol messages (WAP), and the like. In one embodiment, the browser application is enabled to employ a Handheld Device Markup Language (HDML), Wireless Markup Language (WML), WMLScript, JavaScript, and the like, to display and send a message.

Mobile device 104 also may include at least one client application with components that that are configured to communicate content with another computing device, such as another mobile device, network device, and the like. The client application may include a capability to provide and receive textual content, graphical content, audio content, and the like. The client application may further provide information that identifies itself, including a type, capability, name, identifier, and the like. The information may also indicate a content format that mobile device 104 is enabled to employ. Such information may be provided in a message, or the like, sent to server network device 106, and the like.

Mobile device 104 may be configured to communicate a message, such as through a Short Message Service (SMS), Multimedia Message Service (MMS), instant messaging (IM), internet relay chat (IRC), mIRC, Jabber, and the like, between another computing device, such as server 106, and the like. However, the present invention is not limited to these message protocols, and virtually any other message protocol may be employed.

Wireless network 110 is configured to couple mobile device 104 and its components with WAN/LAN 102. Wireless network 110 may include any of a variety of wireless sub-networks that may further overlay stand-alone ad-hoc networks, and the like, to provide an infrastructure-oriented connection for mobile device 104. Such sub-networks may include mesh networks, Wireless LAN (WLAN) networks, cellular networks, and the like.

Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G) generation radio access for cellular systems, WLAN, Wireless Router (WR) mesh, and the like. Access technologies such as 2G, 3G, and future access networks may enable wide area coverage for mobile devices, such as mobile device 104 with various degrees of mobility. For example, wireless network 110 may enable a radio connection through a radio network access such as Global System for Mobil communication (GSM), General Packet Radio Services (GPRS), Enhanced Data GSM Environment (EDGE), Wideband Code Division Multiple Access (WCDMA), and the like. In essence, wireless network 110 may include virtually any wireless communication mechanism by which information may travel between mobile device 104 and another computing device, network, and the like.

Network 105 is configured to couple server 106 and its components with other computing devices, including, client network device 102, server network 106, and through wireless network 110 to mobile device 104. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 405 includes any communication method by which information may travel between server 406 and another computing device.

Additionally, communication media typically embodies computer-readable instructions, data structures, program modules, or other data, which may be transmitted in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic media, RF media, infrared media, and other wireless media.

Illustrative Mobile Client Environment

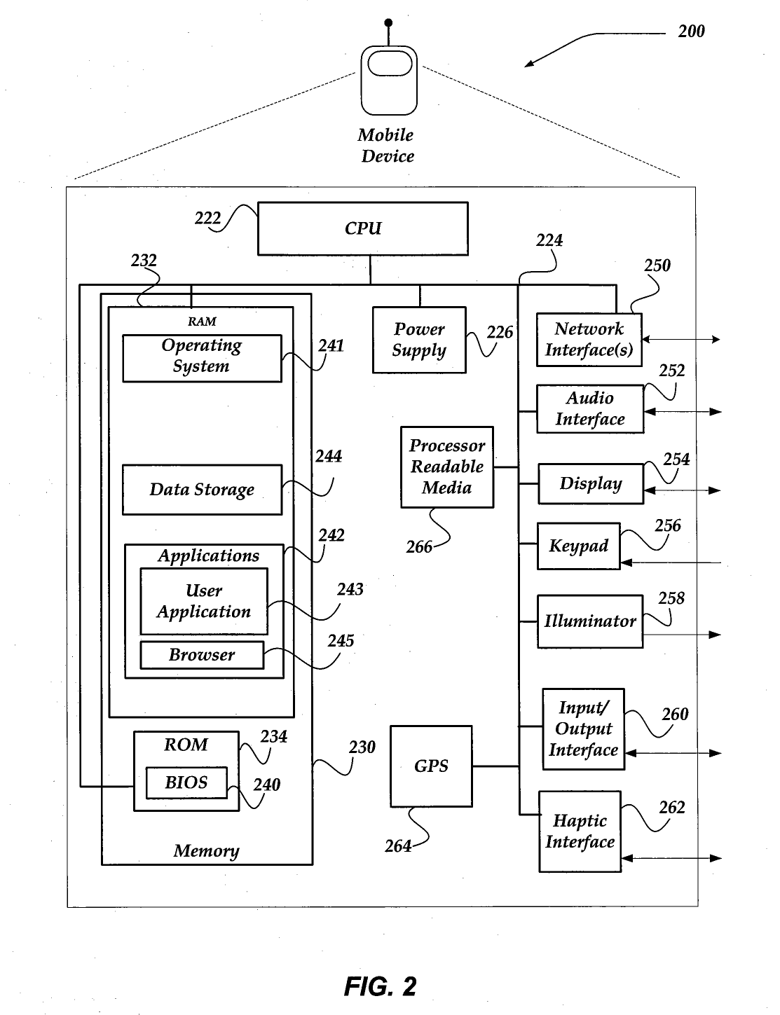

FIG. 2 shows one embodiment of mobile device 200 that may be included in a system implementing the invention. Mobile device 200 may include many more or less components than those shown in FIG. 2. However, the components shown are sufficient to disclose an illustrative embodiment for practicing the present invention. Mobile device 200 may represent, for example, mobile device 104 or client network device 102 of FIG. 1.

As shown in the figure, mobile device 200 includes a processing unit (CPU) 222 in communication with a mass memory 230 via a bus 224. Mobile device 200 also includes a power supply 226, one or more network interfaces 250, an audio interface 252, a display 254, a keypad 256, an illuminator 258, an input/output interface 260, a haptic interface 262, an optional global positioning systems (GPS) receiver 264, and processor readable media 266. Media 266 may include, but is not limited to, hard discs, floppy disks, memory cards, optical discs, and the like. Power supply 226 provides power to mobile device 200. A rechargeable or non-rechargeable battery may be used to provide power. The power may also be provided by an external power source, such as an AC adapter or a powered docking cradle that supplements and/or recharges a battery.

Mobile device 200 may optionally communicate with a base station (not shown), or directly with another computing device. Network interface 250 includes circuitry for coupling mobile device 200 to one or more networks, and is arranged for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Mobile device 200 also comprises input/output interface 260 for communicating with external devices, such as a headset, or other input or output devices not shown in FIG. 2. Input/output interface 260 can utilize one or more communication technologies, such as USB, infrared, Bluetooth™, or the like. Haptic interface 262 is arranged to provide tactile feedback to a user of the client device. For example, the haptic interface may be employed to vibrate mobile device 200 in a particular way when another user of a computing device is calling.

Optional GPS transceiver 264 can determine the physical coordinates of mobile device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of mobile device 200 on the surface of the Earth. It is understood that under different conditions, GPS transceiver 264 can determine a physical location within millimeters for mobile device 200; and in other cases, the determined physical location may be less precise, such as within a meter or significantly greater distances.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of mobile device 200. The mass memory also stores an operating system 241 for controlling the operation of mobile device 200. It will be appreciated that this component may include a general purpose operating system such as a version of UNIX, or LINUX™, or a specialized client communication operating system such as Windows Mobile™, or the Symbian® operating system. The operating system may include, or interface with a Java virtual machine module that enables control of hardware components and/or operating system operations via Java application programs.

Memory 230 further includes one or more data storage 244, which can be utilized by mobile device 200 to store, among other things, applications 242 and/or other data. For example, data storage 244 may also be employed to store information that describes various capabilities of mobile device 200. The information may then be provided to another device based on any of a variety of events, including being sent as part of a header during a communication, sent upon request, or the like. Data storage 244 may also be employed to store social networking information including vitality information, or the like. At least a portion of the social networking information may also be stored on a disk drive or other storage medium (not shown) within mobile device 200.

Applications 242 may include computer executable instructions which, when executed by mobile device 200, transmit, receive, and/or otherwise process messages (e.g., SMS, MMS, IM, email, and/or other messages), audio, video, and enable telecommunication with another user of another client device. Other examples of application programs include calendars, browsers, email clients, IM applications, SMS applications, VoIP applications, contact managers, task managers, transcoders, database programs, word processing programs, security applications, spreadsheet programs, games, search programs, and so forth. Applications 242 may further include browser 245 and a user application 243.

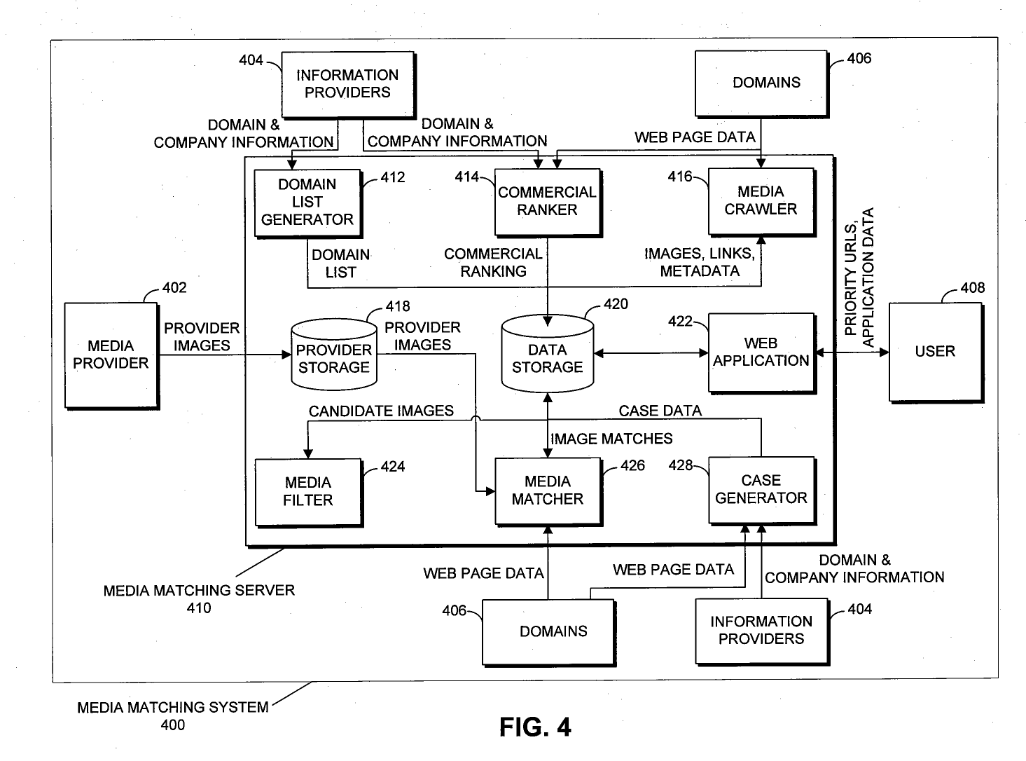

User application 243 may comprise a graphical user interface, an application program, a browser plug-in, a downloaded client application, or other application. The user application generally enables a media provider, target-generator, administrator, media broker, or other user to interact with a matching service, a media brokering system, a network node, or other service. In addition, or alternatively, user application 243 may comprise a matching service, a media brokering system, or a component of such systems. Various embodiments of the processes for application 243 are described in more detail below in conjunction with FIGS. 4-12.

Illustrative Network Device

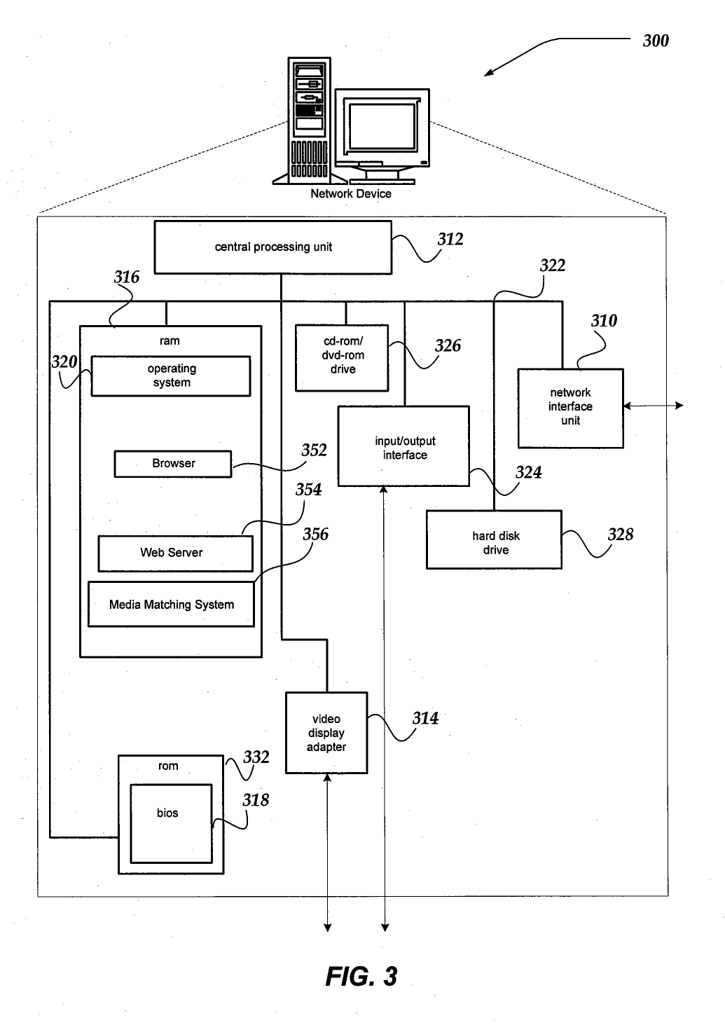

FIG. 3 shows one embodiment of a network device, according to one embodiment of the invention. Network device 300 may include many more components than those shown. The components shown, however, are sufficient to disclose an illustrative embodiment for practicing the invention. Network device 300 may be arranged to represent, for example, server network device 106 or client network device 101 of FIG. 1.

Network device 300 includes processing unit 312, video display adapter 314, and a mass memory, all in communication with each other via bus 322. The mass memory generally includes RAM 316, ROM 332, and one or more permanent mass storage devices with processor readable media, such as hard disc drive 328, tape drive, optical drive, memory card, and/or floppy disk drive. The mass memory stores operating system 320 for controlling the operation of network device 300. It is envisioned that any general-purpose or mobile operating system may be employed. Basic input/output system (“BIOS”) 318 is also provided for controlling the low-level operation of network device 300. As illustrated in FIG. 3, network device 300 also can communicate with the Internet, or some other communications network, via network interface unit 310, which is constructed for use with various communication protocols including the TCP/IP protocol. Network interface unit 310 is sometimes known as a transceiver, or network interface card (NIC).

The mass memory as described above illustrates another type of processor-readable media, namely computer storage media. Computer storage media may include volatile, nonvolatile, removable, and non-removable processor readable media implemented in any method or technology for storage of information, such as processor readable instructions, data structures, program modules, or other data. Examples of computer storage media include RAM, ROM, EEPROM, flash memory or other memory technology, CD-ROM, digital versatile disks (DVD) or other optical storage, memory cards, magnetic cassettes, magnetic tape, magnetic disk storage or other magnetic storage devices, or any other medium which can be used to store the desired information and which can be accessed by a computing device.

The mass memory also stores program code and data. One or more applications 350 can be loaded into mass memory and run on operating system 320. Examples of application programs that may be included are transcoders, schedulers, calendars, database programs, word processing programs, HTTP programs, customizable user interface programs, IPSec applications, encryption programs, security programs, VPN programs, SMS message servers, IM message servers, email servers, account management and the like.

The client applications may include browser 352, Web server 354, Media matching system 356, Media Licensing System 357, and the like. Furthermore, one or more serving applications may be arranged on one or more network devices dedicated to providing computing resources.

Web server 354 may also be arranged to provide content as a service to sources and/or resellers of selected content to customers. Media matching system 356 determines domains or other sources to search for copies or versions of digital media that match, or are based on digital media that is controlled for licensing. Various embodiments of the processes for media matching system 356 are described in more detail below in conjunction with FIGS. 4-12. Media Licensing System 357 may enable content to be submitted by a content provider, reviewed by a reviewer, and licensed by a customer. Media Licensing System 357 may also manage cases of unlicensed and/or licensed digital media. Additionally, network device 300 is arranged to enable one or more of the processes described below in conjunction with FIGS. 4-11.

### Generalized Operation

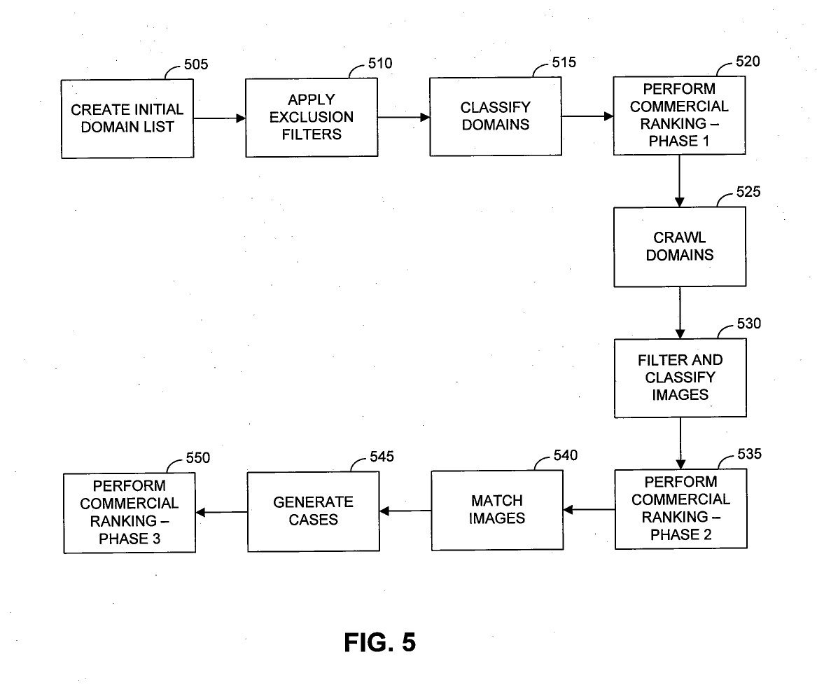

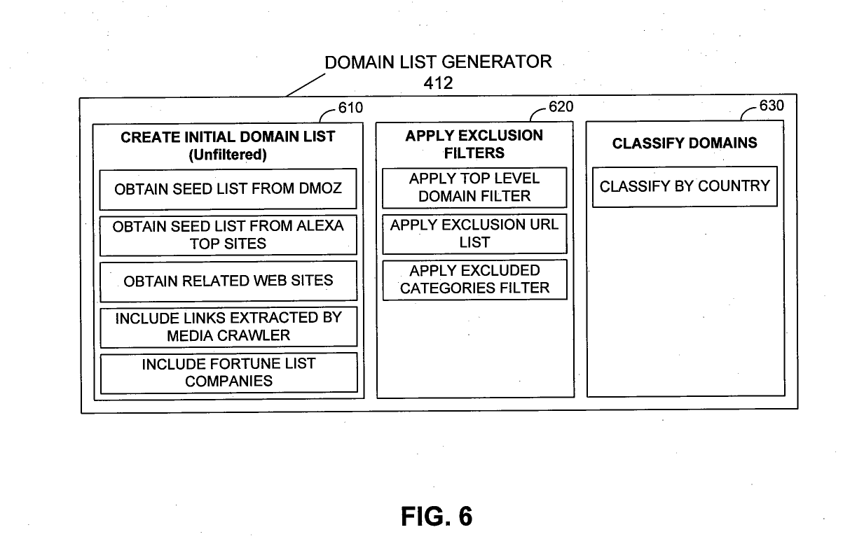

The operation of certain aspects of the invention will now be described with respect to FIGS. 4-12. FIG. 4 provides a general system diagram of an embodiment. FIG. 5 provides a general flow diagram of an embodiment. FIGS. 6-12 provide additional details concerning the major functions and operation of the various components of the invention.

Reference is now made to FIG. 4, which is a simplified diagram of an example media matching system 400 for the Web, in accordance with an embodiment of the subject invention. Media matching system 400 may interact with, or be a component of a media licensing system. In one embodiment, source content from one or more different sources is processed/ingested from a content provider. This intake process can be adapted for different sources that provide source content in different ways, such as providing an electronic file on a processor readable media or over a network. Source content can also be provided on physical media such as a photograph, book, poster, painting, and the like. The “physical” source content is processed into an electronic format. A digital fingerprint and/or a unique identifier may be applied to and/or associated with each copy of the source content. A copy of customer-selected source content is provided to a customer for licensing.

To maintain proper licenses, to identify additional licensing opportunities, and/or to enforce digital media rights, a media matching process checks digital media on other nodes. In one embodiment, a process is arranged to crawl one or more public websites, private websites, or other sites, on one or more networks, to identify stored copies of content. The process may employ licensing and/or sales information to determine if a site owner is licensed to use the identified content for its current use. This license compliance information can be provided to one or more resources including, but not limited to, content provider sales representatives, content provider marketing representatives, content provider licensing representatives, and content provider's anti-piracy enforcement and compliance representatives. Additionally, although this exemplary embodiment is directed to image content, the invention is not so limited, and can be applied to at least the other types of content discussed elsewhere in the specification.

Example media matching system 400 attempts to match media provided by a media provider 402 with media found on the Web, in web domains 406. For purposes of discussion, the digital media referred to in FIGS. 4-12 and in the description below are digital images.

Media matching functions and services are provided by a media matching server 410. Media matching server 410 includes a web application 422 that provides a variety of services to a user 408. Typical services provided by web application 422 to a user 408 are notification that images have been matched, information about the owner of the domain(s) where matching images were found, the time period during which matching images were found on the Web, and reporting capabilities. For purposes of clarity, user 408 refers to a person that uses a standard web browser such as Microsoft Internet Explorer or Mozilla Firefox to access web application 422. It should be noted that the terms domain and website may be used interchangeably to refer to a collection of web pages that share a similar Internet domain address. The term uniform resource locator (URL) generally refers to a specific web page or media file accessible on a network node, such as those accessible through the Web. Other methods may be used to access media files, such as file transfer protocol (FTP), peer-to-peer connections, desktop application programs with connections to other nodes, or the like.

A media provider 402 may be a person or organization that supplies one or more digital images to a provider storage 418 in order to have media matching server 410 identify matching images on the Web. Provider storage 418 is a data storage system that accepts images, henceforth referred to as “provider images” across the web using a web communications protocol. Typical web protocols suitable for conveying images are simple object access protocol (SOAP), hypertext transfer protocol (HTTP), and file transfer protocol (FTP). Provider storage 418 uses a database management system, typically a relational database management system, to store the provider images onto physical data storage systems such as a hard disc or optical disc.

A domain list generator 412 creates a domain list which is a list of candidate URLs that are to be crawled by a media crawler 416. Domain list generator 412 stores the domain list in a data storage 420. Domain list generator 412 is described in greater detail with respect to FIG. 6. Data storage 420 stores data used by media matching server 410 including inter alia the domain list, images, metadata, URLs, case information and application data. Data storage 420 uses a database management system, typically a relational database management system, to store data onto physical data storage systems such as a hard disc or optical disc.

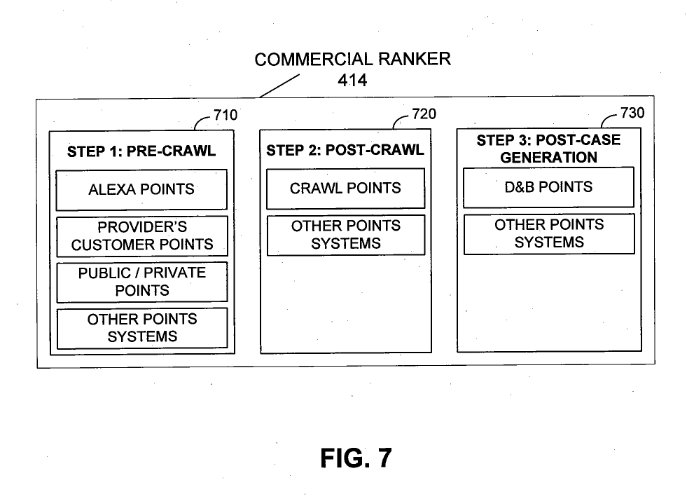

For each domain 406 in the domain list, a commercial ranker 414 estimates its commercial value and applies a ranking value using domain information obtained from one or more information providers 404 and from information obtained directly from web pages in said domain 406. Commercial ranker 414 is described in greater detail with respect to FIG. 7.

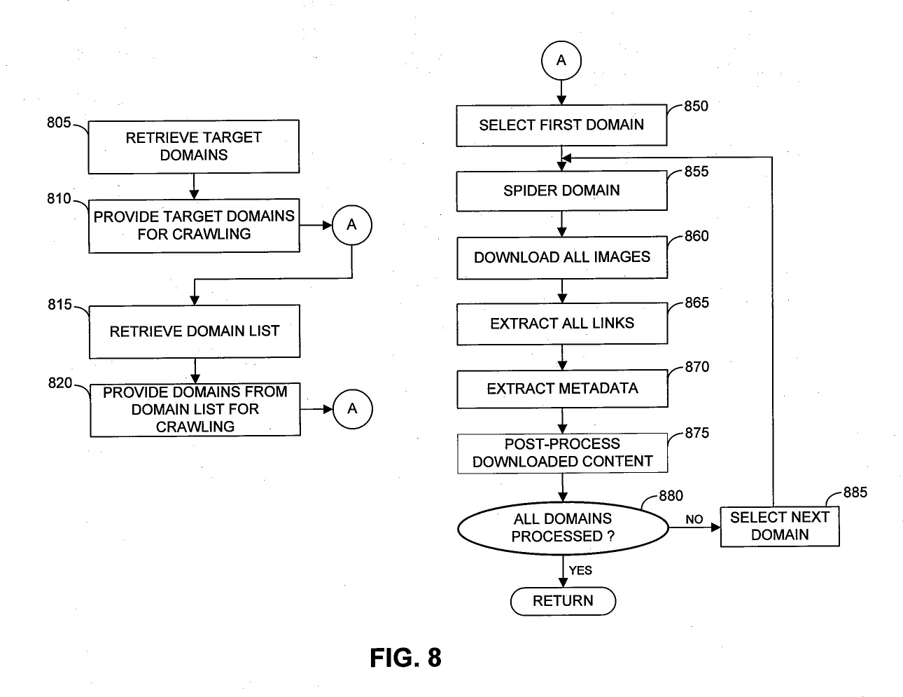

For each domain 406 in the domain list, a media crawler 416 identifies each web page in said domain, downloads each image and/or other media file that appears in each web page in said domain, and extracts metadata from said web pages. In one embodiment, media crawler 416 also extracts the URL for each media file and/or hyperlink, or simply “link”, in each web page in the domain. Media crawler 416 stores images, metadata and URLs into data storage 420. Media crawler 416 stores “candidate images” that are further analyzed to determine if they match provider images stored in provider storage 418. Media crawler 416 is described in greater detail with respect to FIG. 8.

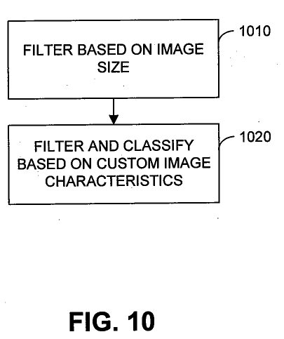

A media filter 424 analyzes each candidate image downloaded by media crawler 416 and stored in data storage 420 to determine whether said candidate image may be successfully matched with an image in provider storage 418. Media filter 424 classifies each image into a category where the category determines how an image will subsequently be processed. Media filter 424 is described in greater details with respect to FIG. 10.

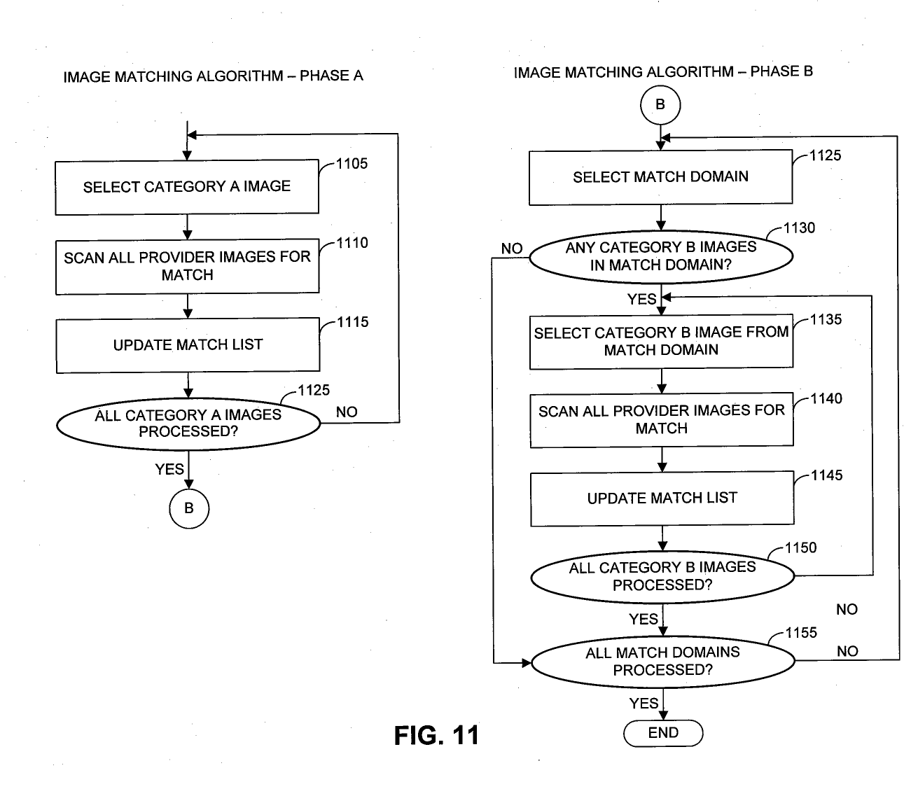

A media matcher 426 attempts to match said filtered images to images stored in provider storage 414. Media matcher 426 is described in further detail with respect to FIG. 11.

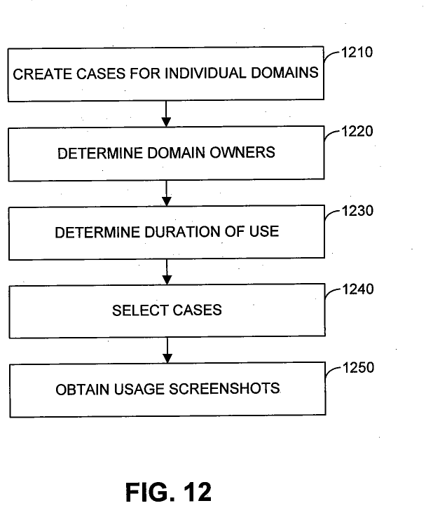

For each image match, a case generator 428 generates a database record, commonly referred to as a “case” in data storage 420. Case generator 428 attempts to obtain information concerning the owner of the image match by consulting with one or more information providers 404 and also by analyzing information found on web pages in domain 406 where said image match appears. Case generator 428 is described in further detail with respect to FIG. 12.

It will be appreciated by those skilled in the art that the media matching server 410 may be embodied in a single server computer or distributed over a plurality of server computers that are communicatively coupled with one another. Any of the individual subsystems, for example media crawler 416, may be embodied in a separate computer, in a single computer, or distributed over more than one computer.

Reference is now made to FIG. 5, which is a logical flow diagram generally showing a process for matching media on the Web, in accordance with an embodiment of the subject invention. At Step 505 domain list generator 412 creates a list of candidate URLs, referred to as a “domain list”, that are to be crawled by a media crawler 416. At Step 510 domain list generator 412 applies one or more exclusion filters to the initial domain list that delete unwanted domains and provide a filtered domain list. At Step 515 domain list generator 412 attempts to classify all websites represented by the list of URLs in the filtered domain list to produce a filtered and classified domain list. Websites may be classified according to a variety of criteria including the country in which they operate.

At Step 520 commercial ranker 414 performs a phase 1, or first step, processing to rank websites in the filtered and classified domain list according to their commercial potential. Phase 1 uses information supplied by media provider 402 and information providers 404 to assign a commercial ranking to each domain in the domain list. At Step 525 media crawler 416 performs up to two crawling steps. In a first step, media crawler 416 crawls a list of target domains specified by user 408 using a user interface provided by web application 422 provided that such list has been provided. In a second step media crawler 416 crawls the domain list in a specified order where the order is based on criteria such as commercial ranking, date of insertion into the domain list, and number of domains from each country. Media crawler 416 downloads all images from each domain crawled, and retrieves metadata from each domain and stores the image data and metadata in data storage 420.

At Step 530 media filter 424 filters and classifies images that have been previously downloaded by media crawler 416 to improve the efficiency of the subsequent processing by media matcher 426.

At Step 535 commercial ranker 414 uses information obtained by media crawler 416 to improve the accuracy of the commercial ranking of domains that have been crawled. Examples of information obtained by media crawler 416 that might be used are the number of web pages in the domain and the number of images in the domain.

At Step 540 media matcher 426 attempts to match Web images that have been downloaded by a media crawler 416 with images provided by a media provider 402. In one embodiment, Web images are classified into three categories: Category A images that are excellent prospects for matching, Category B images that are medium prospects for matching, and Category C images which are not prospects for matching and may be discarded. Media matcher 426 performs a two phase matching algorithm. In the first phase the algorithm attempts to match each Category A image with each content provider image stored in provider storage 418. In the second phase Category B images are compared to images from each domain from the domain list that contained at least one Category A image that matched at least one content provider image. Step 540 processing yields a list of “match images” each of which appears in a Web page and matched an image supplied by media provider 402.

At Step 545 case generator 428 creates “leads” for domains in which match images were found where a lead is a relational database structure that contains all relevant information about the match images found in a domain. Each lead is further qualified using commercial ranking and potentially other information to yield cases that are supplied to Web application 422.

Finally, at Step 550 commercial ranker 414 uses the domain owner information deduced by case generator 428 to obtain information about the domain owner from information providers 404 and adjust the commercial ranking of domains in the domain list accordingly.

Reference is now made to FIG. 6, which depicts the processing performed by a domain list generator 412, in accordance with an embodiment of the subject invention. At Step 610 domain list generator 412 obtains lists of domains or websites from one or more information providers 404 and creates an initial, unfiltered, domain list. It should be noted that said domain list is list of URLs where each URL is presumably the home page, i.e. top level web page, of a website. Publicly available sources of lists of web sites that may be obtained and incorporated into the initial domain list include the open directory project, referred to as DMOZ, Alexa Top Sites which provide ranked lists of websites ordered by traffic or other criteria, and Alexa Related Links which provide lists of websites related to provided list of websites. Information about DMOZ is available at http://www.dmoz.org/. Information about Alexa Top Sites and Alex Related Links are available at http://www.alexa.com. In addition, all outgoing links extracted by media crawler 416 may be added to the initial domain list. Finally, in this example, websites operated by Fortune magazine's lists of 1000, 500, 100 and 50 companies may be added. Other sources may be added that are associated with the list of websites.

At Step 620 domain list generator 412 applies one or more exclusion filters to the initial domain list to delete unwanted domains. A top level domain filter may be applied that eliminates domains that do not have specified domain extensions. For example, the top level domain filter may specify with .com, .net, .co.uk, .de, .hk extensions. Any domain address with a different extension is eliminated from the domain list. An exclusion URL list that causes explicitly specified domains to be excluded from the domain list may also be applied. As an example of how this might be used, media provider 402 may want to exclude their parent company and any affiliates since it would be in their normal course of business to use provider images on their websites.

An excluded categories filter may enable user 408 to specify specified categories of websites to be excluded from further processing. For example, if media provider 402 has licensed its images broadly to the U.S. Government then it may want to exclude all U.S. Government websites. Acting on behalf of media provider 402, user 408 may use web application 422 to specify categories to be excluded. The DMOZ classification of websites into categories provides one method for identifying and excluding websites on a category basis. At Step 620, domain list generator 412 may remove excluded domains from the domain list stored in data storage 420 to produce a new domain list that has been filtered.

At Step 630 domain list generator 412 attempts to classify all websites represented by the list of URLs in the filtered domain list. In one embodiment, websites are classified as to what country they operate in. Domain list generator 412 may use company information obtained from Fortune Magazine's Fortune 1000 list to determine in which country a company primarily operates. In addition, country information can be obtained from the Alexa service. Domain list generator 412 adds classification information for each domain in the domain list stored in data storage 420 to produce a filtered and classified domain list.

In one embodiment domain list generator 412 runs periodically. The first time it runs domain list generator produces an initial domain list. Subsequently, domain list generator 412 is used to update the current domain list; in this embodiment, domain list generator produces a new domain list which is compared to the current domain list. Domains that appear in the new domain list but which do not appear in the current domain list are added to the current domain list.

Reference is now made to FIG. 7 which depicts the processing performed by a commercial ranker 414 that ranks the commercial potential of Web domains, in accordance with an embodiment of the subject invention. Commercial ranker 414 executes in three steps; each step is performed at a different point in the media matching workflow. The goal of commercial ranker 414 at each step is to make use of newly available and newly collected data to determine and assign a commercial ranking to each domain in the domain list. The commercial ranking is used subsequently by the web application 422. Commercial ranker 414 uses a “points system” to assign a commercial ranking. In one embodiment, commercial ranker assigns from 1 to 5 points for each information source, where a score of 5 points is awarded if commercial ranker 414 estimates with high confidence that the domain being evaluated is a commercial website and a score of 1 point is awarded if commercial ranker 414 estimates with high confidence that the domain being evaluated is not a commercial website.

In another embodiment, the commercial ranking is a series of vectors where each vector is used to rank the commercial potential relative to a specific criteria. For example, one vector might estimate whether the Web domain performs ecommerce. If many web pages in the domain include a shopping cart then 5 points might be assigned whereas if no shopping cart is present then the this vector might be assigned a 1. Another vector might evaluate the content on a site where certain types of content, e.g. sports or entertainment might receive a high ranking while news or editorial content information might receive a lower ranking. Generally, many vectors may be used for commercial ranking. In one embodiment, commercial ranker 414 performs a computation that generates an overall ranking. One example equation that might be used is:

$$Commercial ranking = {\sum }_{i = 1}^{K} ( w ( i ) ⋆ Vector ( i ) ) ,$$

where w(i) is the weight for vector i and Vector(i) is the value of vector(i) for a series of K vectors.

In addition, a ‘plus’ factor may be used for prioritizing. For example, a porn site that is considered offensive may need to be analyzed regardless of whether it has commercial potential or not. The ‘plus’ factor may be in addition to a commercial ranking or it may be one of a series of commercial ranking vectors.

Commercial ranker 414 Step 1 processing is performed after domain list generator 412 creates the domain list and prior to execution of media crawler 416. Step 1 processing uses information supplied by media provider 402, and information providers 404 to assign a commercial ranking to each domain in the domain list. In addition, or alternatively, information may be supplied based on a ‘screen scrape’ in which the fully rendered web page that displays on a client computer is captured and analyzed. For instance, a screen scrape may be used to identify a shopping cart, a credit card payment ability, or other aspect.

Commercial ranker 414 Step 2 processing is performed after execution of media crawler 416. Step 2 processing uses information obtained by media crawler 416 that can be used to improve the commercial ranking of domains that have been crawled. Examples of information obtained by media crawler 416 that might be used are the number of web pages in the domain and the number of images. Commercial ranker 414 Step 2 processing adjusts the commercial ranking of domains in the domain list.

Commercial ranker 414 Step 3 processing is performed after execution of case generator 428. Step 3 processing uses the domain owner information deduced by case generator 428 to obtain information about the domain owner from information providers 404. As an example, commercial ranker 414 might obtain a domain owner's Dun & Bradstreet rating which is a composite score of a firm's financial strength and creditworthiness provided by Dun & Bradstreet, which is available at www.dnb.com. Commercial ranker 414 Step 2 processing adjusts the commercial ranking of domains in the domain list.

Reference is now made to FIG. 8 which depicts the processing performed by a media crawler 416, in accordance with an embodiment of the subject invention. Media crawler 416 is in many respects comparable to commercially available web crawlers which are programs or automated scripts that browse the Web in a methodical, automated manner in order to obtain updated information. However, there are differences between commercially available web crawlers and media crawler 416. Importantly, rather than try and crawl the entire Web, media crawler 416 performs two types of crawling: a target crawl and a general crawl.

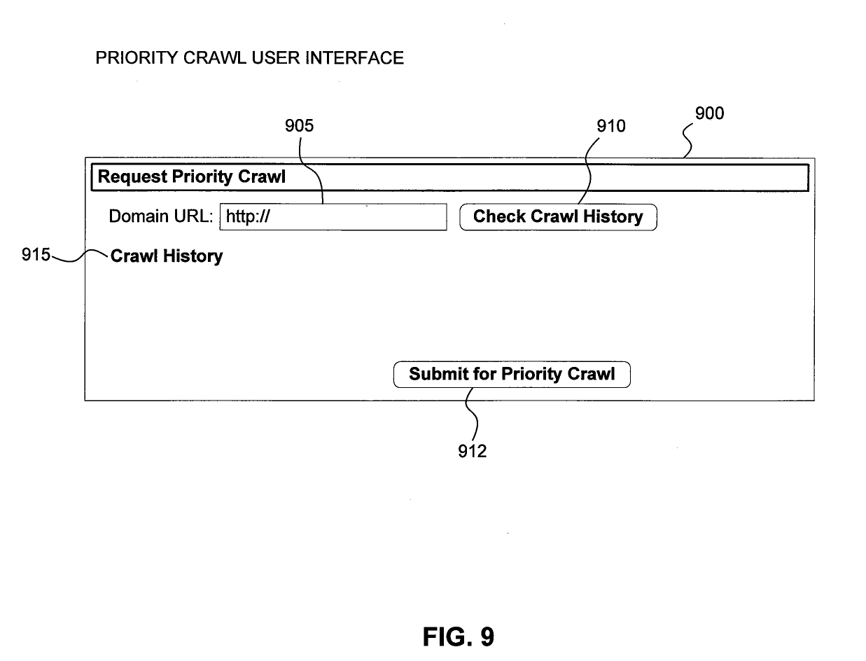

At Step 805 media crawler 416 retrieves a list of target, or priority, domains. Target domains or websites are specified by user 408 using a user interface provided by web application 422. Said user interface enables the user to enter a list of uniform resource locations (URLs) that define domains to search for potential “match images” where a match image is defined to be an image on the Web that matches an image provided by media provider 402. An example user interface that enables user 408 to enter target, or priority, domains is provided in FIG. 9. At Step 810, media crawler 416 provides the list of target domains to Step 850 to perform a target crawl.

At Step 815 the domain list created by domain list generator 412 is retrieved. In one embodiment, media crawler 416 prioritizes the domain list by specific criteria. Examples of criteria that might be used to select domains to crawl include commercial ranking, date of insertion into the domain list, and number of domains from each country. Then, at Step 820 media crawler 416 provides some or all of the domains in the domain list to Step 850 to perform a general crawl.

At Step 850, media crawler 416 selects the first URL from the list that was provided to it. Each URL in the domain list is treated as an initial or seed URL for the domain. At Step 855 media crawler 416 spiders the domain to create a list of URLs, each corresponding to a web page that it will process. Spidering is commonly performed by web crawlers and refers to the process of identifying all of the related web pages in a website. There are many well known algorithms for spidering. For example, WebLech is an open source program for spidering a website, available on the Web at: http://weblech.sourceforge.net/. At Step 860 media crawler 416 downloads all images from the domain and stores them in data storage 420. At Step 865, media crawler 416 extracts all links from each web page in the domain. New links, i.e. links that do not refer to domains in the domain list, are added to the domain list by domain list generator 412 (Step 610, FIG. 6). Next, at Step 870 media crawler 416 extracts metadata from the domain and stores it in data storage 420. Examples of metadata that may be collected include the number of web pages in the domain and the number of images in the domain, the sizes of each image in the domain, the web page code for one or more web pages in the domain, and HTML tag information that may provide supplemental information regarding an image displayed in a web page such as an “ALT” attribute that is used to define alternative text for an image. At Step 875 media crawler 416 post-processes web content that has been downloaded from the domain in the previous steps to identify new or modified content and to identify parts of the content on the crawled website that have been deleted.

Web content retrieved by web crawler included the elements defined in Table 1 below.

TABLE 1
Web Content Retrieved For Each Crawled Image

| Content Item | Type | Description |
|---|---|---|
| Address | URL | Address of the image |
| Page Address | URL | Address of the Web page in which the |
| | | image appears |
| Metadata | TAG | Tag information from the HTML tag that |
| | | defines the image |
| Scan_Date_Time | Date & Time | Date the image was detected by the |
| | | crawler |
| Image_Size | Width, Height | The width and height in pixels of the |
| | | image. |
| Image_Type | Text | Image file types supported on the Web |
| | | include GIF and JPEG. |
| ImageData | File | A file containing the pixel image data. |

At Step 880 a determination is made as to whether all domains have been processed. If so, then processing is complete. If not, then the next domain is selected and processing returns to Step 885.

Reference is now made to FIG. 9 which is an example user interface for specifying high priority URLs for a media crawler, in accordance with an embodiment of the subject invention. User 408 accesses target crawl user interface 900 via web application 422. User 408 enters a valid URL into entry box 905 and then clicks on either a check crawl history button 910 or a submit for priority crawl button 912. If user 408 clicks on check crawl history button 910 then information regarding media crawler crawling of the URL entered into entry box 905 appears in the area under the words “Crawl History” 915. Examples of crawl history information that may be supplied are a list of dates/times when media crawler 416 crawled the corresponding domain, the number of web pages crawled in the domain, and the number of images that appeared in web pages in the domain. If user 408 clicks on submit for priority crawl button 912 then the URL is added to the list of priority, or target, domains described with reference to FIG. 8.

Reference is now made to FIG. 10 which is a flowchart describing the filtering and classification of images downloaded by a media crawler 416, in accordance with an embodiment of the subject invention. Images downloaded by media crawler 416 are filtered and classified in order to improve the efficiency of the subsequent processing by media matcher 426. At Step 1010 images are filtered based on image size. In one embodiment, images with dimensions less than 128 pixels in width or height are discarded, i.e. are not processed any further. In another embodiment, images with a total number of pixels less than a specified size where the total number of pixels is computed by multiplying the width of the image in pixels times the height of the image in pixels. Next, at Step 1020 images are filtered and classified based on custom image characteristics. Typically, an image matching algorithm such as the one employed by media matcher 426 requires that the images to be matched meet certain specifications or criteria. For example, some image matching algorithms will work on color images but not on black and white images; some image matching algorithms will work on photorealistic images that depict naturally occurring scenes but not on digital images that include substantial amounts of text, such as a fax or a scan of a text document. At Step 1020 images are analyzed to ensure that they meet the criteria required by media matcher 426. In one embodiment, images are classified into three categories: Category A images that are excellent prospects for matching, Category B images that are medium prospects for matching, and Category C images which are not prospects for matching and are thus discarded. The presence of a digital watermark may also be taken into account when classifying images. A digital watermark is a message which is embedded into digital content (audio, video, images or text) that can be detected or extracted later. Such messages may carry copyright information for the content or it may carry a unique identifier that can be used as an index into a database that stores copyright, licensing or other information. In one embodiment, if a digital watermark is detected then an image might be classified as a category A image.

Reference is now made to FIG. 11 which a flowchart describing the processing of a media matcher 426 that matches Web images that have been downloaded by a media crawler 416 with images provided by a media provider 402, in accordance with an embodiment of the subject invention. Media matcher 426 performs a two phase image matching algorithm. In the first phase the algorithm attempts to match each Category A image with each content provider image stored in provider storage 418. In the second phase Category B images are compared to the images downloaded from each domain from the domain list that contained at least one Category A image that matched at least one content provider image. In the description hereinafter a domain that contains at least one Category A image that matched a content provider image is referred to as a “match domain.” The second phase of the image matching algorithm processes Category B images that appear in web pages in a match domain to determine if they match a content provider image.

Referring to FIG. 11, at Step 1105 a Category A image is selected. At Step 1110 media matcher 426 attempts to match the selected Category A image with each provider image. Note that a Category A image matches a provider image if it is determined to be either the exact same image, pixel-for-pixel, or a version of the provider image. A version of an image includes any image that results from digital processing of the original image. Typical digital processing of an original image that will result in a new version includes inter alia resizing to fit in a different size rectangular area within a web page, cropping a portion of the image, changing the color of the original image, applying artistic filters, and combining the original image with other digital images. A variety of algorithms can be used to match two digital images. Matching of two digital images has been the subject of considerable research and many algorithms have been reported in public research or are available in commercial products.

At Step 1115, for each match detected in Step 1110, the selected Category A image URL is added to a match list together selected metadata describing the provider image that matched. At Step 1120 a determination is made as to whether all Category A images have been processed. If not, then processing returns to Step 1105; if so, then processing continues at Step 1125.

The second phase of the image matching algorithm begins with Step 1125. At Step 1125 a match domain is selected for processing. At Step 1130 a determination is made as to whether there are any Category B images from said match domain, i.e. is there a Category B image that appears on a web page in the selected match domain. If there are no such Category B images then processing continues at Step 1155. If so, then processing continues at Step 1135 where one Category B image from the match domain is selected. At Step 1140 media matcher 426 attempts to match the selected Category B image with each provider image. At Step 1145, for each match detected in Step 1140, the selected Category B image URL is added to a match list together with selected metadata for the selected Category B provider image that matched.

At Step 1150 a determination is made as to whether all Category B images in the match domain have been processed. If not, then processing returns to Step 1135; if so, then at Step 1155 a determination is made as to whether all match domains from the match list have been processed. If not, then processing returns to Step 1125; if so, then the algorithm terminates.

Reference is now made to FIG. 12 which depicts the processing performed by a case generator 428 that creates case records, in accordance with an embodiment of the subject invention. At Step 1210 case generator 428 creates a “lead” for each domain in which a match image was found. For purposes of clarity, a lead is a relational database structure that includes information about the domain and about each match image found in the domain. An example of a relational database table that provides information about one domain is given in Table 2 below. An example of a relational database table that provides information about one match image is given in Table 3 below.

TABLE 2
Lead - Domain Owner Properties

| Property | Type | Description |
|---|---|---|
| Domain_Name | Key | Common name of the domain |
| Domain URL | URL | Internet address of the domain |
| Owner_Name | Text | Name of the owner of the domain |
| Domain_Owner_Address | Address | Mailing address of the domain owner |
| Domain_Owner_Phone | Telephone # | Telephone number of the domain owner |
| Domain_commercial_ranking | Integer | The commercial ranking of the domain |
| | | determined by commercial ranker 414 |
| Scan_Date_Time | Date & Time | Most recent date/time that the domain was |
| | | crawled by media crawler 416. |
| Domain_traffic | Integer | The amount of traffic, typically measured |
| | | in unique visitors per month, to the |
| | | domain. |

TABLE 3
Lead - Match Image Properties

| Property | Type | Description |
|---|---|---|
| Domain_Name | Key | Common name of the domain in which |
| | | the match image was found |
| Provider_Image_Name | Key | Name of the provider image |
| Match_Image_URL | URL | Internet address of the match image |
| Match_Image_Size | Width, Height | The width and height in pixels of the |
| | | image. |
| ImageData | File | A file containing the pixel image data. |
| Number_Matched | Integer | Number of times the match image was |
| | | matched to the provider image (this |
| | | defines the number of Scan_Dates listed |
| | | below). |
| Scan_Date #1 | Date & Time | First date the match image was matched to |
| | | the provider image |
| Scan_Date #N | Date & Time | Most recent date the match image was |
| | | matched to the provider image |
| First_appearance | File | A screen capture of the earliest |
| | | appearance of the match image in the |
| | | domain. |

Leads are stored in data storage 420. If some of domain properties indicated in Table 2 are missing, then at Step 1220 case generator 428 obtains missing domain and company information from information providers 404. Company information, as listed in Table 2, may include the company name, address, and telephone number. Domain information, as listed in Table 2, may include the domain traffic.

At Step 1230 case generator 428 attempts to determine the duration that each match image has been in use in a domain. Case generator 428 may use publicly available services that archive websites and provide snapshots of many or all of the web pages in a domain at specific dates to determine the date of first use of a match image. An example of such a publicly available service for obtaining archived websites can be found at http://www.archive.org/. In one embodiment, case generator 428 processes each snapshot of a domain where a match image was found in reverse chronological order, i.e. starting with the oldest snapshot, and compares the match image to each image in the snapshot to determine when the oldest instance of a match occurs. This is then considered to be the first instance of usage of the match image in the domain.

At Step 1240 each lead is analyzed to determine if the commercial ranking of the target is high enough to be either manually or automatically selected as a ‘case.’ Leads which are not determined to have a high enough commercial ranking are given low priority and/or not further processed. Cases are subsequently processed by web application 422.

At Step 1250 case generator 428 obtains screenshots of one or more web pages in the domain that display a match image. Said screenshots provide both visual evidence that the domain displayed a match image and evidence of the earliest date that can be detected by case generator 428 that the image appeared in the domain. It should also be noted that at Step 1250 case generator 428 may also store web pages from a domain that contain contact information for the owner or operator of the domain.

The above specification, examples, and data provide a complete description of the manufacture and use of the composition of the invention. Thus it may be appreciated that the subject invention is advantageous for use with any digital media types including videos and video clips, movies, images, graphics, music, and spoken word recordings.

For example, in one embodiment, the subject invention processes digital sound or music files. In this embodiment, sound or music files are provided by a media provider 402, are crawled and downloaded by media crawler 416, are filtered by media filter 424, and are matched by media matcher 426.

For example, in one embodiment, the subject invention processes digital video files. In this embodiment, digital video files are provided by a media provider 402, are crawled and downloaded by media crawler 416, are filtered by media filter 424, and are matched by media matcher 426.

It will be understood that each block of the above illustrations, and combinations of blocks in the illustrations, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks.

Accordingly, blocks of the illustrations support combinations of means for performing the specified actions, combinations of steps for performing the specified actions and program instruction means for performing the specified actions. It will also be understood that each block of the illustration, and combinations of blocks in the illustration, can be implemented by special purpose hardware-based systems which perform the specified actions or steps, or combinations of special purpose hardware and computer instructions.

The subject invention may be incorporated into a comprehensive system for media licensing and enforcement, it may be used independently or may be incorporated into other types of applications. Since many embodiments of the invention can be made without departing from the spirit and scope of the invention, the invention resides in the claims hereinafter appended.

What is claimed as new and desired to be protected by Letters Patent is:

1. A method for matching media files, comprising:
receiving from a media provider a media file to be matched;
creating a list of domains to be evaluated to determine whether any of the domains include a matching media file that matches the media file;
applying to the list of domains an exclusion filter that eliminates specified domains from the list based on criteria defined by a user;
crawling the domains to identify one or more potentially matching media files that are potential matches for the media file provided by the media provider;
classifying each potentially matching media file into one of a plurality of categories; and
evaluating each potentially matching media file to determine whether each potentially matching media file matches the media file provided by the media provider.

2. The method of claim 1 wherein said media file is an image.

3. The method of claim 1 wherein said media file is an audio file.

4. The method of claim 1 wherein said media file is a video file.

5. The method of claim 1 further comprising discarding at least one potentially matching media file that was classified into a discard category.

6. The method of claim 1 further comprising ranking the domains in the domain list for commercial potential based on publicly available information.

7. The method of claim 1 further comprising ranking the domains in the domain list for commercial potential based on information obtained by crawling web pages.

8. A method for matching media files with media files that appear on web pages, comprising:
receiving from a media provider one or more media files to be matched;
creating a list of domains to be evaluated to determine if any of the media files to be matched appears on web pages in said domains;
applying exclusion filters to the list of domains that eliminate specified domains from the list based on criteria defined by a user;
crawling the Web to identify and download media files that are potential matches for media files provided by said media provider;
classifying each downloaded media file into one of a plurality of categories;
attempting to match each media file classified into one or more of the said categories with each media file provided by said media provider; and
generating a case for each domain that contains at least one media file on a web page that matches at least one media file provided by said media provider where said case includes information about the owner of said domain and information about each instance where a media file on a web page in said domain matches a media file provided by said media provider.

9. The method of claim 8 wherein said media files are images.

10. The method of claim 8 wherein said media files are sound or music files.

11. The method of claim 8 wherein said media files are video or film files.

12. The method of claim 8 such that media files classified into at least one of said categories are discarded and not processed further.

13. The method of claim 8 further comprising ranking domains in the domain list for commercial potential based on information about the domain obtained from information providers.

14. The method of claim 8 further comprising ranking domains in the domain list for commercial potential based on information obtained by crawling of web pages.

15. The method of claim 8 further comprising ranking domains in the domain list for commercial potential based on information about the domain owner obtained from information providers.

16. A network device for matching media files, comprising:
a network interface unit that is arranged to send and receive data over a network;
a processor; and
a processor-readable storage medium storing instructions which when executed on the processor enable actions, including:
receiving from a media provider a media file to be matched;
creating a list of domains to be evaluated to determine whether any of the domains include a matching media file that matches the media file;
applying to the list of domains an exclusion filter that eliminates specified domains from the list based on criteria defined by a user;
crawling the domains to identify one or more potentially matching media files that are potential matches for the media file provided by the media provider;
classifying each potentially matching media file into one of a plurality of categories; and
evaluating each potentially matching media file to determine whether each potentially matching media file matches the media file provided by the media provider.

17. The network device of claim 16, wherein the processor-readable storage medium stores instructions which further enable ranking the domains in the domain list for commercial potential based on publicly available information.

18. The network device of claim 16, wherein the processor-readable storage medium stores instructions which further enable discarding at least one potentially matching media file that was classified into a discard category.

19. The network device of claim 16, wherein said media files are image files.

20. An article of manufacture including a processor-readable medium having processor-executable code stored therein, which when executed by one or more processors enables actions for matching media files comprising:
receiving from a media provider a media file to be matched;
creating a list of domains to be evaluated to determine whether any of the domains include a matching media file that matches the media file;
applying to the list of domains an exclusion filter that eliminates specified domains from the list based on criteria defined by a user;
crawling the domains to identify one or more potentially matching media files that are potential matches for the media file provided by the media provider;
classifying each potentially matching media file into one of a plurality of categories; and
evaluating each potentially matching media file to determine whether each potentially matching media file matches the media file provided by the media provider.
